(19) United States
(12) Patent Application Publication
(10) Pub. No.: US 2005/0241898 A1
(43) Pub. Date: Nov. 3, 2005

(54) Cylinder assembly

(75) Inventor: John D. Stepto, Parkesburg, PA (US)

Correspondence Address: JAMES RAY & ASSOCIATES, 2640 PITCAIRN ROAD, MONROEVILLE, PA, 15146, US

(73) Assignee: KV Pneumatics, Inc.

(21) Appl. No.: 11/120,611

(22) Filed: May 3, 2005

Related U.S. Application Data
(60) Provisional application No. 60/567,493, filed on May 3, 2004.

(51) Int. Cl. F16D 65/00

(52) U.S. Cl. 188/322.17; 188/73.1

(57) ABSTRACT

A cylinder assembly includes a housing with a cylindrical aperture, a plurality of stationary attached members which divide the cylindrical aperture into a plurality of fluid chambers, a rod axially disposed within the aperture through each stationary member and a plurality of pistons disposed within each fluid chamber and attached to the rod at a predetermined distance. A plurality of longitudinal apertures are axially spaced from the cylindrical aperture with one of such apertures connected to a source of fluid. A series of first passages connects each fluid chamber to such aperture which is connected to the source of fluid. A drive means is attached to one end of the rod for enabling a reciprocal motion thereof. Such reciprocal motion enables the fluid to enter each fluid chamber through the series of first passages and exit each chamber through its associated fluid output at equal volume and flow rate at each output.

### CROSS-REFERENCE TO RELATED APPLICATIONS

This application is related to and claims priority from U.S. Provisional Patent Application Ser. No. 60/567,493 filed on May 3, 2004.

### FIELD OF THE INVENTION

The present invention relates, in general, to a cylinder assembly and, more particularly, the instant invention relates to a cylinder assembly having a plurality of pistons mounted to a single rod and, still more particularly, the instant invention relates to a pump apparatus employing a multi-piston cylinder assembly.

### BACKGROUND OF THE INVENTION

The following background information is provided to assist the reader to understand the environment in which the invention will typically be used. The terms used herein are not intended to be limited to any particular narrow interpretation unless specifically stated otherwise in this document.

It is well known that in a variety of fluid related applications, it is required to simultaneously dispense a fluid from a plurality of fluid outputs with equal flow rates and equal volumes. The examples of such applications would include an automated paint device utilizing a plurality of nozzles, a water spraying system used in a car wash, and a food processing system dispensing a liquefied food element on a moving conveyor through a plurality of nozzles.

Generally, such applications utilize a fluid system arrangement wherein each nozzle is connected to a separate fluid transfer device such as a cylinder or pump. Each of these devices must be connected to a fluid source and further connected to a drive means resulting in complexity of installation and increased installation costs. Additionally, each device must be separately controlled and adjusted to meet various application requirements, thus impacting overall system reliability.

As can be seen from the above discussion, there is a need for a relatively simple and reliable fluid device which receives fluid from a single fluid source and dispenses fluid from a plurality of outputs with equal flow rates and equal volumes.

### SUMMARY OF THE INVENTION

The present invention overcomes the disadvantages of the presently used devices by employing a cylinder assembly including a housing which has a first aperture and a plurality of axially aligned second apertures, one of which is connected to a fluid source. A plurality of stationary attached members divide the first aperture into a plurality of fluid chambers, with each fluid chamber connected by a distinct first passage to such second aperture connected to the fluid source. A rod is axially disposed within the first aperture and extends through each stationary member. A plurality of pistons are employed in the present invention with each piston disposed within each fluid chamber and attached to the rod at a predetermined distance. Sealing elements are provided for sealing the engagement of the rod with each stationary member and each piston. Each piston is provided with a peripheral seal engaging an inner surface of the first aperture and enabling the fluid to flow in one direction within each fluid chamber. A drive means including a drive screw and a drive nut arrangement is attached to the rod at one end and is coupled to a prime mover at the other end enabling a reciprocal motion of the rod upon continuous rotation reversal of the prime mover. Such reciprocal motion of the rod enables the fluid to enter each fluid chamber through the series of first passages and exit each chamber through its associated second passage at an equal volume and equal flow rate. Directional fluid flow control devices are provided to enable fluid flow into each fluid chamber from the fluid source and enable fluid flow to each output from each fluid chamber. A first sensor attached to the rod and a second sensor attached to the housing generate a positional signal when such first and second sensors are aligned.

### OBJECTS OF THE INVENTION

It is, therefore, one of the primary objects of the present invention to provide a cylinder assembly which is generally more reliable.

Another object of the present invention is to provide a cylinder assembly which is capable of delivering a fluid received at a common fluid input to a plurality of fluid outputs.

Still another object of the present invention is to provide a cylinder assembly which exhibits equal flow rate from each output.

Yet another object of the present invention is to provide a cylinder assembly which exhibits independent flow from each output.

A further object of the present invention is to provide a cylinder assembly which is compact in size.

Yet still another object of the present invention is to provide a cylinder assembly which will reduce manufacturing costs.

An additional object of the present invention is to provide a cylinder assembly which can incorporate directional flow control devices.

In addition to the various objects and advantages of the present invention which have been generally described above, there will be various other objects and advantages of the invention that will become more readily apparent to those persons who are skilled in the relevant art from the following more detailed description of the invention, particularly, when the detailed description is taken in conjunction with the attached drawing figures and with the appended claims.

### BRIEF DESCRIPTION OF THE DRAWINGS

FIG. 1 is a perspective view of a cylinder assembly of a presently preferred embodiment of the present invention in combination with a pump drive;

FIG. 2 is a partial cross-sectional perspective view of the cylinder assembly taken along the lines 2-2 in FIG. 1; and

FIG. 3 is a schematic representation, partially in cross-section, of the cylinder assembly of the present invention particularly illustrating a fluid flow.

### DESCRIPTION OF THE PRESENTLY PREFERRED AND VARIOUS ALTERNATIVE EMBODIMENTS OF THE INVENTION

Before describing the invention in detail, the reader is advised that, for the sake of clarity and understanding, identical components having identical functions have been marked where possible with the same reference numerals in each of the Figures provided in this document.

Now refer more particularly to FIGS. 1-3. Illustrated therein is a single rod multi-piston fluid pump of the present invention, generally designated 10, having a fluid distribution means, generally designated 20, including a housing 22 of a predetermined shape and a predetermined length. The housing 22 has a first aperture 24 of a predetermined size axially disposed therein and at least one second axial aperture 26 circumferentially spaced about such first aperture 24. Preferably such fluid distribution means 20 is a cylinder assembly and the housing 22 is manufactured from an aluminum extrusion. Preferably, such first aperture 24 is substantially cylindtrical and such multi-piston pump 10 includes a plurality of apertures 26 axially disposed and circumferentially spaced about the first aperture 24.

In the presently preferred embodiment, one of such plurality of second axial apertures 26, referenced as 28, is adapted with a fluid input end 32 for receiving a fluid 100 from a single fluid source (not shown). The second end 33 of the aperture 28 is closed. The fluid 100 may be a gaseous matter, such as air, or a liquid.

The housing 22 has at least one first passage 30 extending from an outer surface 23 through the aperture 28 into the first aperture 24. The end of such at least one first passage 30 adjacent the outer surface 23 of the housing 22 is closed. The housing 22 is further provided with at least one second passage 34 extending from the outer surface 23 directly into the first aperture 24. Preferably such at least one first passage 30 and such at least one second passage 34 are disposed transversly to such first and second apertures 24 and 28 respectively. At least one t-slot aperture 38 logitudinally extends from the outer surface 23.

The cylinder assembly 20 includes at least a pair of partitions 40 disposed within the first aperture 24 at a predetermined distance therebetween which form at least one closed fluid chamber 43. Each of such pair of partitions 40 is rigidly attached to the housing 22, preferably with at least one fastener 68 engaging at least one third aperture 36 extending from the outer surface 23 of the housing 22 and at least one complimentarily aligned cavity 41 disposed within each of such pair of partitions 40.

In order to seal the engagement of such pair of partitions 40 with inner surface 25 of the first aperture 24, each partition 40 is adapted with at least one first peripheral compressible sealing means 45, each disposed within a peripheral cavity 44 of such partition 40 and engaging the inner surface 25.

Each of the partitions 40 includes an axially disposed aperture 42 adapted to receive a rod 46 axially disposed within the first aperture 24. At least one first compressible sealing means 62 is provided to prevent fluid flow through engagement of the rod 46 with the aperture 42 of each partition 40.

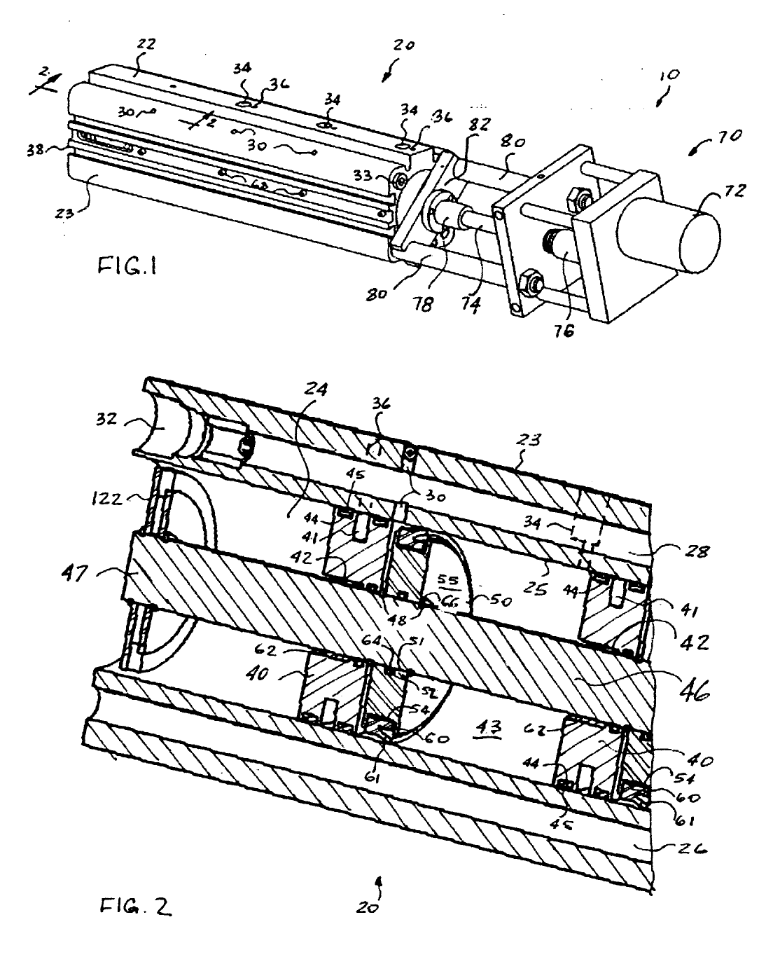

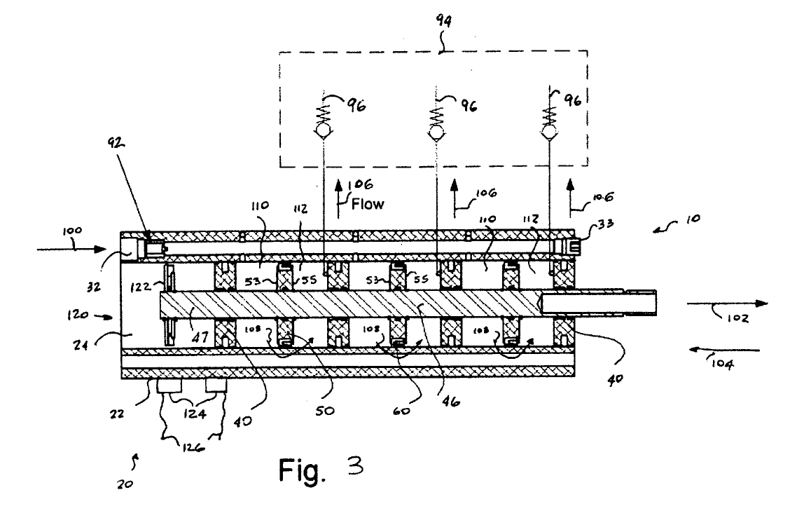

In further reference to FIGS. 2 and 3, at least one piston 50 having a first surface 53 and a second surface 55 is disposed within the fluid chamber 43. The piston 50 has an axially disposed aperture 51 for receiving the rod 46. A second compressible sealing means 64 is disposed within a peripheral cavity 52 of the piston 50 for eliminating fluid flow through such aperture 51.

The piston 50 is adapted with at least one second peripheral compressible sealing means 60, each disposed within a peripheral cavity 54 disposed in an outer edge surface of such piston 50. In the presently preferred embodiment, such second peripheral compressible sealing means 60 is a well known U-cap seal 60 having a flexible portion 61 with one end thereof engaging the inner surface 23 of the first aperture 24 of the housing 22. The distal end of the flexible portion 61 is disposed at a predetermined distance from the inner surface 23 resulting in an angular orientation of the flexible portion 61 in relationship to the inner surface 23.

The piston 50 is prevented from substantial axial displacement with respect to the rod 46 by a pair of retaining clips 66, each disposed within a complimentary peripheral cavity 48 of the rod 46.

The pump 10 of the present invention includes a drive means, generally designated 70, best shown in FIG. 1, engageable with one end of the rod 46 for enabling reciprocal motion thereof. In the presently preferred embodiment, such drive means 70 includes a prime mover 72 coupled to a first drive member 74 with a coupling means 76. A second drive member 78 engages first drive member 74 for linear motion thereto and is rigidly connected to the end of the rod 46. Preferably, first drive member 74 is a lead screw 74, the second drive member 78 is a drive nut 78, the prime mover 72 is an electric prime mover having a connection with a control system (not shown) for such drive means 70.

It is preferred that means 80 is provided for direct attachment of such drive means 70 to the housing 22 and a member 82 engageable with the drive nut 78 and attachment means 80 is also provided for preventing rotation of the drive nut 78 during linear motion thereof about the lead screw 74. Alternatively, such drive means 70 may be attached to any rigid stationary structure (not shown).

Alternatively, such drive means 70 may be a pneumatic or hydraulic cylinder (not shown) connectable to one end of the rod 46 and capable of producing such reciprocal motion thereof.

To enable a directional input flow of the fluid 100 into the housing 22, a first directional flow means 92 is disposed within the fluid input end 32 of the aperture 28. To enable a directional output flow of the fluid 100, at least one second directional flow means 96 is disposed inline with the at least one second passage 34. Preferably, such second directional flow means 96 is disposed within a flow control module 94 used with a cylinder assembly 20 having a predetermined plurality of fluid chambers 43.

It will be appreciated that in reference to FIG. 2, the rod 46 is disposed in a retracted position with such piston 50 having the first surface 53 disposed adjacent the partition 40 and at a predetermined distance therefrom. It will be further appreciated that first passage 30 is disposed at one end of fluid chamber 43 and is aligned intermediate one of the partition 40 and a first surface 53 of the piston 50. The second passage 34 is disposed adjacent the distal end of the fluid chamber 43 opposite the second surface 55 of the piston 50.

The operation of the cylinder assembly 20 of the presently preferred embodiment is illustrated for use within pump 10 as best shown in FIGS. 1 and 3, wherein cylinder assembly 20 has a plurality of equal volume fluid chambers 43 and corresponding plurality of pistons 50 attached to the single rod 46.

It will be appreciated that a plurality of the fluid chambers 43, pistons 50, first and second passages 30 and 34 respectively will be determined based on a specific application.

Initial rotation of the prime mover 72 in the first rotational direction will enable the lead screw 74 to move in a first direction 102 and, more particularly, will enable the rod 46 to move each piston 50 in such first direction 102. Such movement of the pistons 50 in the direction 102 will form a first portion 110 and a second portion 112 within each fluid chamber 43 with the fluid 100 entering each first portion 110 through each of the first passages 30 connected with the aperture 28. Reversal of the prime mover 72 rotation will enable the rod 46 and the plurality of pistons 50 to move in a second direction 104 which is opposite to the first direction 102.

Since the first directional flow means 92 prevents fluid flow in the second direction 104, the fluid 100 will transfer to the second portion 112 through the U-cap seal 60 in a direction 108. When the rod 46 reaches its original position, best shown in FIG. 2, each of the second portions 112 will be occupied with the fluid 100. Another reversal of the prime mover 72 in the first rotational direction will enable the fluid 100 to flow through each of the second passages 34 in a direction 106 and will enable the fluid 100 to occupy the first portion 110. Yet another reversal of the prime mover 72 in the second direction will enable the fluid 100 to occupy the second portion 112 as the second directional flow means 96 prevents reverse flow of the fluid 100 into each second portion 112 through each second passage 34.

Those skilled in the art will understand that such continuous reciprocal motion of the rod 46 in the first direction 102 and the second direction 104 will enable continuous flow of the fluid 100 in the direction 106 from each fluid chamber 43 through a plurality of second passages 34. Equal volume of each fluid chamber 43 and equal size of the second passages 34 enable such fluid 100 to flow at equal rates and volumes through each second passage 34. Furthermore, utilization of the directional U-cap seal 60 enables the rod 46 to generate a fluid pressure in the second portion 112 of such plurality of chambers 43 and communicate such fluid pressure through each second passage 34.

Advantageously, a flow restriction in one of such plurality of second passages 34 will provide for unrestricted flow of fluid 100 through the remaining second passages 34, as each of such plurality of second passages 34 is independently operable by their respective chambers 43.

To enable the flow of the fluid 100 and control the flow rate thereof through each second passage 34, the pump 10 may be provided with means 122 for determining position of the rod 46. In the presently preferred embodiment such means 122 is magnetic position sensor 122 attached to the distal end 47 of the rod 46, and best shown in FIGS. 2 and 3, cooperating with at least one second position sensor 124 adjustably attached to the outer surface 23 of the housing 22, preferably in t-slot apertures 38. The second position sensor 124 has an electrical connection 126 with the control system (not shown) for the drive means 70. When the first position censor 122 and the second position sensor 124 are aligned, the later generates an electrical signal which is communicated to the control system (not shown) enabling it to monitor the position of the rod 46 and reverse rotation of the prime mover 72.

Continuous reversals of prime mover 72 rotation will cause the reciprocal motion of rod 46 in the first and second directions 102 and 104, respectively. Advantageously, utilization of a pair of second position sensors 124 disposed at each end of rod 46 travel, as shown in FIG. 3, further enables the control system (not shown) to monitor a travel speed of the rod 46 and selectively adjust such speed for selectively adjusting the flow rate of the fluid 100.

Alternatively, means 122 may be a well-known encoder (not shown) attached to the prime mover 72 or such means 122 may be a visual indication means (not shown) cooperating with the linear scale (not shown) disposed on outer surface 23 of housing 22.

Although the present invention has been described in terms of using the cylinder assembly within a pump apparatus to deliver fluid through a plurality of outputs with equal volume and equal rate available through each output, it will be apparent to those skilled in the art, that the present invention may be used in applications requiring only a single fluid chamber but where it is advantageous to utilize longitudinal apertures within an aluminum extrusion for porting purposes and eliminate porting through the end caps.

It will be further apparent to those skilled in the relevant art that a multi piston cylinder assembly of the present invention may be applied in combination with a power tool to generate a high thrust force. In such application piston peripheral sealing means will be provided to substantially seal such first portion from such second portion, a fluid under pressure will be supplied to a plurality of first portions generating such high trust force, and each of the second portions will be vented into atmosphere.

It will be understood that the U-cap seal 60 of the presently preferred embodiment may be replaced with a seal that either permits flow of the fluid 100 in both directions within each chamber 43 or substantially seals such first portion 110 from such second portion 112 and significantly prevents such flow of the fluid 100 therebetween.

While the presently preferred embodiment of the instant invention has been described in detail above in accordance with the patent statutes, it should be recognized that various other modifications and adaptations of the invention may be made by those persons who are skilled in the relevant art without departing from either the spirit of the invention or the scope of the appended claims.

1. A cylinder assembly comprising:
(a) a housing having a predetermined shape and a predetermined length;
(b) a first aperture having a predetermined shape and disposed within said housing;
(c) at least one second aperture disposed within said housing and longitudinally aligned with said first aperture, said at least one second aperture radially spaced from said first aperture, said at least one second aperture has a first end connected to a fluid source;
(d) at least one pair of partitions engaging a surface of said first aperture and forming at least one chamber in said housing;
(e) means engageable with each of said at least one pair of partitions for rigidly securing them within said first aperture;
(f) a rod axially disposed within said first aperture and extending through said at least one pair of partitions;
(g) at least one piston disposed within said at least one chamber and secured to said rod for axial movement therewith, said at least one piston forming a first portion and a second portion within said at least one chamber, said first portion disposed adjacent a first surface of said at least one piston and said second portion disposed adjacent an axially opposed second surface of said at least one piston;
(h) at least one first passage connecting said at least one chamber with said at least one second aperture having connection with said fluid source, said at least one first passage aligned with said first portion of said at least one chamber for delivering a fluid from said fluid source into said first portion; and
(i) at least one second passage extending from an outer surface of said housing for direct engagement with said first aperture, said at least one second passage aligned with said second portion of said at least one chamber.

2. The cylinder assembly according to claim 1, wherein said at least one first passage extends from said outer surface of said housing.

3. The cylinder assembly according to claim 1, wherein said predetermined shape of said first aperture is cylindrical.

4. The cylinder assembly according to claim 1, wherein said housing is aluminum.

5. The cylinder assembly according to claim 1, wherein said housing is an extrusion.

6. The cylinder assembly according to claim 1, wherein said cylinder assembly further includes means for sealing engagement of said at least one pair of partitions with said first aperture and said rod.

7. The cylinder assembly according to claim 1, wherein said cylinder assembly further includes means engageable with said at least one piston and said first aperture for sealing said first portion of said at least one chamber from said second portion.

8. The cylinder assembly according to claim 7, wherein said means for sealing said first portion from said second portion enables a directional fluid flow between said first portion and said second portion.

9. The cylinder assembly according to claim 1, wherein said cylinder assembly further includes means engageable with said first end of said at least one second aperture and connectable with said fluid source for enabling a first directional fluid flow into said first portion of said at least one chamber.

10. The cylinder assembly according to claim 1, wherein said cylinder assembly further includes means engageable with said at least one second passage for enabling a second directional fluid flow from said second portion of said at least one chamber.

11. The cylinder assembly according to claim 1, wherein said cylinder assembly further includes means engageable with a first end of said rod for reciprocally moving it in a first and second direction.

12. The cylinder assembly according to claim 11, wherein said drive means is attached to said housing.

13. The cylinder assembly according to claim 11, wherein said drive means includes:
(a) a prime mover;
(b) a first drive member coupled to said prime mover and rotatable thereby in a first and second direction, said second direction being opposite to said first direction; and
(c) a second drive member engaging said first drive member and disposed for a reciprocal linear movement upon rotation thereof, said second drive member connected to said first end of said rod, whereby energization of said prime mover causes continuous rotation of said first drive member in said first and said second directions and said linear movement of said second drive member, said reciprocal linear movement of said second drive member enables a reciprocal movement of said rod.

14. The cylinder assembly according to claim 11, wherein said drive means further includes control means connectable to said prime mover for selectively controlling rotation of said first drive member.

15. The cylinder assembly according to claim 1, wherein said cylinder assembly further includes means for determining a position of said rod during reciprocal movement thereof.

16. The cylinder assembly according to claim 15, wherein said positioning means includes a first sensor connectable to said rod for linear movement therewith and at least one second sensor rigidly attached to said housing and having an electrical connection with a control means, whereby alignment of said first sensor with said at least one second sensor generates an electrical signal to said control means.

17. A method for using a cylinder assembly to receive a fluid from a single fluid source, generate a fluid pressure and deliver said fluid pressure to a predetermined plurality of independent outputs, said cylinder assembly having an axially disposed first aperture and at least one second aperture axially aligned with said first aperture and radially spaced therefrom, said at least one second aperture connected to said single fluid source, said first aperture having a predetermined plurality of sealed chambers disposed therein and a rod axially extending therethrough, each of said predetermined plurality of chambers has a piston attached to said rod for axial displacement therewith, said piston forming a first portion and a second portion in each of said plurality of chambers, said method comprising the steps of:
(a) forming a plurality of first passages each connecting said first portion with said at least one second aperture connected to said single fluid source;
(b) forming a plurality of second passages each connecting said second portion with a respective one of said predetermined plurality of independent outputs;
(c) providing each piston with a peripheral sealing means for enabling said fluid to flow from said first portion to said second portion;
(d) attaching means to one end of said rod for enabling a reciprocal motion thereof in a first and in an opposed second direction; and
(e) using said motion enabling means to reciprocally move said piston in said first and in said second direction, said piston movable in said first direction generates said fluid pressure at each second passage and enables said fluid to enter said first portion, and whereby said piston movable in said second direction transfers said fluid from said first portion into said second portion through said peripheral sealing means.

18. A method for using a cylinder assembly to generate an increased thrust force at one end of a cylinder rod, said cylinder assembly having a housing with an axially disposed first aperture and at least one second aperture axially aligned with said first aperture and connected to a source of a fluid under pressure, said first aperture having a predetermined plurality of sealed chambers disposed therein and said cylinder rod axially extending therethrough, each of said predetermined plurality of chambers has a piston attached to said cylinder rod for axial displacement therewith, said piston forming a first portion and a second portion in each of said plurality of chambers, said method comprising the steps of:
(a) forming a plurality of first passages each connecting said first portion with said at least one second aperture connected to said single fluid source;
(b) forming a plurality of second passages each connecting said second portion with an outer surface of said housing;
(c) providing each piston with a peripheral sealing means for substantially sealing said first portion from said second portion; and
(d) supplying said fluid pressure to each of said first portions, whereby said supply of said fluid pressure moves said cylinder rod in a first direction and generates a predetermined thrust force at each of said predetermined plurality of pistons, whereby a combination of said predetermined thrust force at each piston provides an increased thrust force at said one end of said
